(19) United States
(12) Patent Application Publication
(10) Pub. No.: US 2011/0056919 A1
(43) Pub. Date: Mar. 10, 2011

(54) Method for Fusing Curved Surfaces, and a Device

(76) Inventors: Bernd Burbaum, Ubach-Palenberg (DE); Selim Mokadem, Dusseldorf (DE); Norbert Pirch, Aachen (DE)

(21) Appl. No.: 12/866,938

(22) PCT Filed: Dec. 16, 2008
(86) PCT No.: PCT/EP08/67637

§ 371 Date: Nov. 23, 2010

(30) Foreign Application Priority Data
Feb. 13, 2008 (DE) 10 2008 008 966.4

(51) Int. Cl. B23K 26/00

(52) U.S. Cl. 219/121.64; 219/121.63

(57) ABSTRACT

A method for fusing a curved surface of a substrate is provided. An energy beam with an energy source and a curved surface of a substrate are provided. The energy beam and/or the substrate are moved toward one another in order to fuse the curved surface and an orientation of the energy beam in relation to the curved surface is varied during the fusing of the curved surface.

### CROSS REFERENCE TO RELATED APPLICATIONS

This application is the US National Stage of International Application No. PCT/EP2008/067637 filed Dec. 16, 2008 and claims the benefit thereof. The International Application claims the benefits of German Application No. 10 2008 008 966.4 DE filed Feb. 13, 2008. All of the applications are incorporated by reference herein in their entirety.

### FIELD OF INVENTION

The invention relates to a process for fusing curved surfaces and to a corresponding device.

### BACKGROUND OF INVENTION

Surfaces of components are repaired by means of a laser powder deposition process, in which material which is fused by the laser is supplied to the surface.

It may likewise be possible for cracks in the component to be re-fused or for regions that have already been welded to be fused a second time, in order to achieve a desired microstructure or in order to repair cracks in the weld seam.

In this context, both flat and curved surfaces are repaired.

However, unsatisfactory welding results are continually obtained in the case of those components which have both flat and curved surfaces.

### SUMMARY OF INVENTION

It is an object of the invention to solve the above-mentioned problem.

The object is achieved by a process as claimed, in which the direction of the energy beam is adapted to the curvature of the surface, and by a device as claimed.

The dependent claims list further advantageous measures which can be combined with one another, as desired, in order to achieve further advantages.

### BRIEF DESCRIPTION OF THE DRAWINGS

FIG. 1 shows a process according to the prior art,

FIG. 2 schematically shows the course of the process according to the invention,

FIG. 3 shows a gas turbine,

FIG. 4 shows a perspective view of a turbine blade or vane,

FIG. 5 shows a perspective view of a combustion chamber, and

FIG. 6 shows a list of superalloys.

The figures and the description show only exemplary embodiments of the invention.

### DETAILED DESCRIPTION OF INVENTION

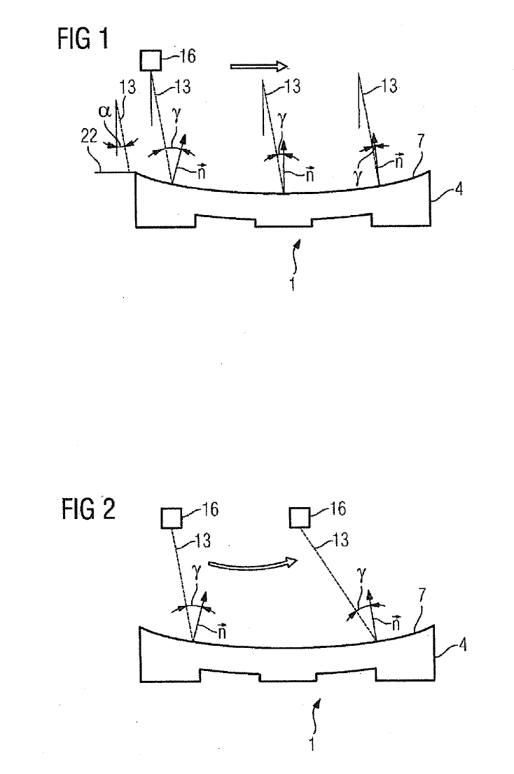

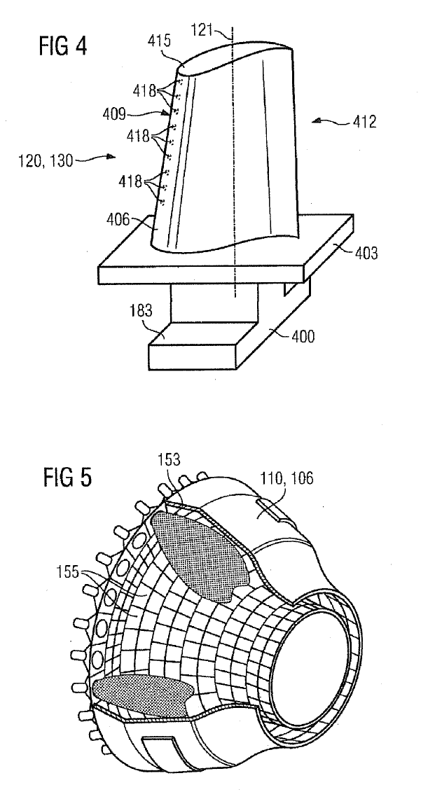

FIG. 1 shows the schematic course of the process according to the prior art, with various positions of an energy source 16, in particular a welding appliance, over a component 1, 120, 130, 155 (FIGS. 4, 5) in a translational direction (from left to right in the drawing).

A substrate 4 of the component 1, 120, 130, 155 has a curved surface 7 with a normal \vec{n} (perpendicular). The direction of the normal \vec{n} changes along the curved surface 7. The curved surface 7 should be fused or re-fused by energy beams 13. This takes place by means of an energy source 16, preferably by means of a plasma or by means of a laser which emits laser beams 13.

The prior art and the invention described below are described only by way of example on the basis of laser welding.

With respect to a flat surface 22 of the substrate 4, a laser beam 13 impinges on the surface 22 at an angle α. The position of the laser 16 is not changed in relation to the substrate 4, even if the laser beam 13 traces the curved surface 7, such that the angle γ between the normal \vec{n} of the surface 7 and the laser beam 13 changes. This often results in cracks during re-fusing or in non-uniform fusion depths, in particular when restructuring directionally solidified (DS, SX) components 120, 130.

FIG. 2 schematically shows the course of the process according to the invention.

If the laser beam 13 impinges on the preferably U-shaped curved surface 7, the position of the laser beam 13 in relation to the substrate 4 is changed such that the angle γ between the laser beam 13 and the normal \vec{n} of the surface 7 preferably remains constant. The degree of change can preferably be adapted continuously.

It may likewise be the case that the position of the laser beam 13 is changed only when there is an angular change Δγ by displacement of the laser 16 and substrate 4 toward one another in the translational direction, and a specific angular change Δγ between the energy beam 13 and the normal \vec{n}, preferably of Δγ=3°, in particular of 1°, very particularly of 0.5°, is exceeded, such that the laser beam 13 is only changed in relation to the surface 7 quasi-continuously.

In the case of a curved surface 7 as in FIG. 2, the position of the laser beam 13 in relation to the curved surface 7 is changed at least three times. The angle is therefore adapted quasi-continuously.

The variation of the angle γ reduces the local variability of the laser power and of the local speed. Since the temperature signal of the focused spot produced by the laser beam is influenced by the change to the angle γ, the temperature of the melt is preferably also not subjected to percent control.

The angle γ is preferably between 8° and 12° and is preferably 10°. The laser power is preferably 750 W. The preheating temperature is preferably 500° C. The speed of movement is preferably 50 mm/min.

Curved surface regions 7 of this type are the transition between the main blade or vane part 406 and the blade or vane platform 403 in the region of the turbine blade or vane 120, 130.

It is likewise preferably possible to adapt the distance between the laser 16 and the surface 7, in particular to keep it constant, since the curvature of the surface 7 means that the distance from the laser 16 changes. The amount of energy introduced into the substrate 4 thereby remains consistent.

The process can likewise be employed for convex surfaces.

Furthermore, welding material can be supplied to the substrate 4, and this material is fused and fills cracks or reinforces component walls.

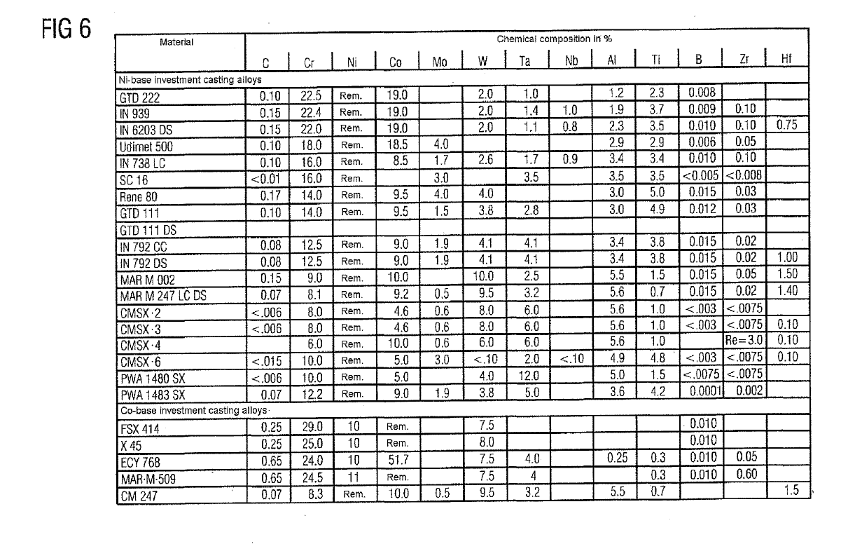

The process is particularly advantageous in the case of a directionally solidified substrate 4 which has grains (DS) solidified in columnar faun or is in the form of a single crystal (SX), since in this case the crystal orientation plays an important role and is influenced during the application of temperature gradients. Substrates 4 preferably have a superalloy according to FIG. 6.

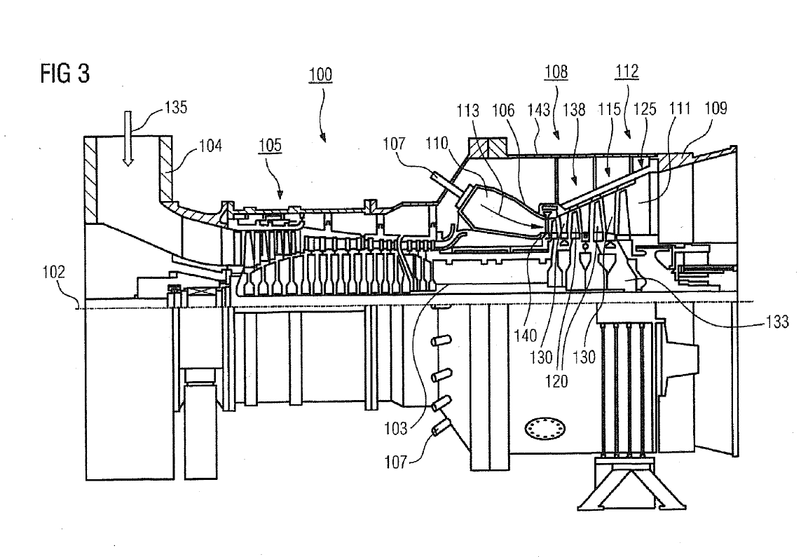

FIG. 3 shows, by way of example, a partial longitudinal section through a gas turbine 100. In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses. To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110. Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a perspective view of a rotor blade 120 or guide vane 130 of a turbomachine, which extends along a longitudinal axis 121. The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415. A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general teams to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density. A protective aluminum oxide layer (TGO=thermally grown oxide layer) is formed on the MCrAlX layer (as an intermediate layer or as the outermost layer). The layer preferably has a composition Co-30Ni-28Cr-8Al-0.6Y-0.7Si or Co-28Ni-24Cr-10Al-0.6Y. In addition to these cobalt-base protective coatings, it is also preferable to use nickel-base protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX. The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal bather coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in foam. If the blade or vane 120, 130 is to be cooled, it is hollow and may also have film-cooling holes 418 (indicated by dashed lines).

FIG. 5 shows a combustion chamber 110 of a gas turbine. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element, or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

1.-15. (canceled)

16. A process for fusing a curved surface of a substrate, comprising:
providing a curved surface of a substrate;
providing an energy beam including an energy source;
moving the energy beam and/or the substrate toward one another in order to fuse the curved surface; and
varying an orientation of the energy beam in relation to the curved surface during the fusing of the curved surface.

17. The process as claimed in claim 16, wherein an angle between a normal of the curved surface and the energy beam is kept constant.

18. The process as claimed in claim 16, wherein an orientation of the energy source of the energy beam in relation to the curved surface is changed quasi-continuously.

19. The process as claimed in claim 18, wherein the orientation of the energy source of the energy beam in relation to the curved surface is changed at least three times.

20. The process as claimed in claim 16, wherein an reorientation of the energy beam in relation to the curved surface is achieved only by rotating the energy source of the energy beam.

21. The process as claimed in claim 16, wherein an reorientation of the energy beam in relation to the curved surface of the substrate is achieved only by rotating the substrate.

22. The process as claimed in claim 16, wherein an reorientation of the energy beam in relation to the curved surface of the substrate is achieved both by rotating the energy source of the energy beam and by rotating the substrate.

23. The process as claimed in claim 16, wherein a distance between the energy source of the energy beam and the curved surface of the substrate is kept constant.

24. The process as claimed in claim 16, wherein an angle between 8° and 12° is set between the energy beam and a normal of the curved surface.

25. The process as claimed in claim 24, wherein an angle of 10° is set between the energy beam and a normal of the curved surface.

26. The process as claimed in claim 16,
wherein the energy source of the energy beam is moved in relation to the curved surface such that an angle between the normal of the curved surface and the energy beam of the energy source changes, and
wherein an orientation of the energy source and of the energy beam is adapted above a change in angle between the energy beam and the normal of 3°.

27. The process as claimed in claim 26, wherein an orientation of the energy source and of the energy beam is adapted above a change in angle between the energy beam and the not mal of 1°.

28. The process as claimed in claim 26, wherein an orientation of the energy source and of the energy beam is adapted above a change in angle between the energy beam and the normal of 0.5°.

29. The process as claimed in claim 16, wherein the energy beam is a laser beam.

30. The process as claimed in claim 16, wherein welding material is supplied to the curved surface.

31. The process as claimed in claim 16, wherein the surface of the substrate is merely re-fused.

32. The process as claimed in claim 30, wherein a fused proportion of the substrate or of the welding material is allowed to solidify in columnar or single-crystal form.

33. The process as claimed in claim 16, wherein the curved surface is U-shaped.

34. A device for fusing a curved surface, comprising:
means for receiving a substrate;
a welding appliance including energy beams;
means for varying an angle between the energy beams of the welding appliance and a normal of the curved surface; and
means for moving a substrate and the welding appliance in relation to one another.
